(19) United States
(12) Patent Application Publication
(10) Pub. No.: US 2002/0138962 A1
(43) Pub. Date: Oct. 3, 2002

(54) Method and apparatus for installing multiple component parts

(76) Inventors: Jack L. Martin, Novi, MI (US); Frank J. Flaga, Clarkston, MI (US)

Correspondence Address: HOVEY, WILLIAMS, TIMMONS & COLLINS, Suite 400, 2405 Grand, Kansas City, MO, 64108, US

(21) Appl. No.: 09/821,382

(22) Filed: Mar. 29, 2001

(51) Int. Cl. B23P 11/00; B23P 19/04

(52) U.S. Cl. 29/430; 294/64.1

(57) ABSTRACT

A method and apparatus for simultaneously installing multiple component parts. The apparatus having a carriage shiftably coupled to a supporting surface, a component part carrier for selectively holding and releasing a plurality of component parts, and a vacuum source circuit providing a vacuum attachment force for holding the component parts to the component part carrier. The process, including the steps of contacting a plurality of part receivers with a plurality of component parts, actuating a vacuum source to thereby temporarily attach the component parts to the part receivers by a vacuum attachment, translating the component part carrier to position the component parts in registry with part reception sites in a platform, and at least partially discontinuing the vacuum attachment force to thereby release the component parts from the part receivers.

### BACKGROUND OF THE INVENTION

1. Field of the Invention

The present invention concerns a method and apparatus for simultaneously installing multiple component parts. The invention further concerns a method and apparatus for simultaneously installing multiple flexible sealing members in the floor of a vehicle body traveling along an assembly line.

2. Description of the Prior Art

During assembly, many vehicles, particularly mini-vans and SUV's, require a plurality of flexible sealing members to be installed in the vehicle floor. These sealing members are placed in cavities in the floor pan where the vehicle seats are coupled to sub-floor anchoring devices. The sealing members act to inhibit the flow of air and debris from below the vehicle floor into the vehicle cabin.

In the past, flexible sealing members were manually installed, one-at-a-time. This installation method required an assembly line worker to crawl into the vehicle cabin and stoop over while installing the individual sealing members. Moreover, the continuous translational movement of the vehicle body along the assembly line inhibits the use of stationary installation devices.

Thus, prior methods of installing sealing members consumed a considerable amount of time due to the manual, one-at-a-time placement of the members. In addition, prior methods of installing sealing members placed physical strain on assembly line workers because the workers were required to stoop over for extended periods of time. Further, prior methods of installing sealing members were dangerous because they required the worker to enter and exit the vehicle body while it was on the assembly line.

### SUMMARY OF THE INVENTION

It is accordingly an object of the present invention to provide a method and apparatus for simultaneously installing multiple component parts in a platform, especially a moving platform, thereby reducing the time required to install the component parts.

It is further an object of the present invention to provide a method and apparatus for simultaneously installing multiple component parts which reduces strain on the human body.

It is still further an object of the present invention to provide a method and apparatus for simultaneously installing multiple component parts in a vehicle on an assembly line which does not require the worker to enter and exit the vehicle, thereby reducing the risk of injury to the worker.

It is another object of the invention to provide an apparatus capable of movement complemental or corresponding to the movement of the receiving platform, whereby production on an assembly line will not be slowed or otherwise inhibited while the component parts are installed.

In one embodiment of the present invention, an apparatus for installing multiple component parts is provided. The apparatus comprises a carriage, a component part carrier, and a vacuum source circuit. The component part carrier has a plurality of part receivers positioned in substantially fixed spatial relationship to one another. Each of the part receivers is adapted for selectively holding and releasing a respective component part. The vacuum source circuit is fluidically connected to the part receivers and comprises a vacuum source and a switch. The switch is selectively actuatable to commence and at least partially discontinue the flow of air from the part receivers to the vacuum source. When the air flow from the part receivers to the vacuum source is commenced, the component parts are temporarily attached to their respective part receivers by vacuum attachment. When the flow of air from the part receivers to the vacuum source is at least partially discontinued, the component parts are released from their respective part receivers. Advantageously, the component part carrier may be mounted by movement, such as translational movement, relative to a base member such as a track or rail, so that the carrier's movement during installation of the component parts is consonant with the movement of the platform along, e.g., an assembly line.

In another aspect of the present invention, a method of simultaneously installing a plurality of component parts into a moving platform is provided. The method comprises the steps of: providing a plurality of component parts; providing a component part carrier having a plurality of part receivers positioned in a substantially fixed spatial relationship to each other; contacting the plurality of part receivers with the plurality of component parts; actuating a vacuum source fluidically connected to the part receivers thereby commencing the flow of air from the part receivers to a vacuum source and temporarily attaching the component parts to the part receivers by a vacuum attachment; translating the component part carrier to position the component parts in registry with a corresponding part reception site in a platform; and, at least partially terminating the flow of air from the part receivers to the vacuum source thereby releasing the component parts from the part receivers. A preferred method includes translating the component part carrier cooperatively with the moving platform so that installation of the parts may continue without the necessity of slowing or stopping the movement of the platform along an assembly line.

### BRIEF DESCRIPTION OF THE DRAWINGS

FIG. 1 is a perspective view of a component part installer according to an embodiment of the present invention;

FIG. 2 is a side view of a component part installer in relation to an assembly line worker and a vehicle body on an assembly line;

FIG. 3 is a plan view of a component part installer and a vehicle body in an initial location on an assembly line, showing the component part installer in retracted position away from the vehicle body;

FIG. 4 is a plan view similar to FIG. 3 of a component part installer and a vehicle body translating along the assembly line to a second location, showing the component part installer adjacent to the vehicle body;

FIG. 5 is a plan view similar to FIG. 3 of a component part installer and vehicle body translating along the assembly line to a third location, showing the component part installer partially extending into the vehicle body;

FIG. 6 is a perspective view of a component part, according to an embodiment of the present invention;

FIG. 7 is an end view of a component part, according to an embodiment of the present invention;

FIG. 8 is a side view of a component part, according to an embodiment of the present invention;

FIG. 9 is a plan view of a component part, according to an embodiment of the present invention; and

FIG. 10 is a vertical cross-sectional view taken along line 10-10 of the component part depicted in FIG. 9.

### DESCRIPTION OF THE PREFERRED EMBODIMENTS

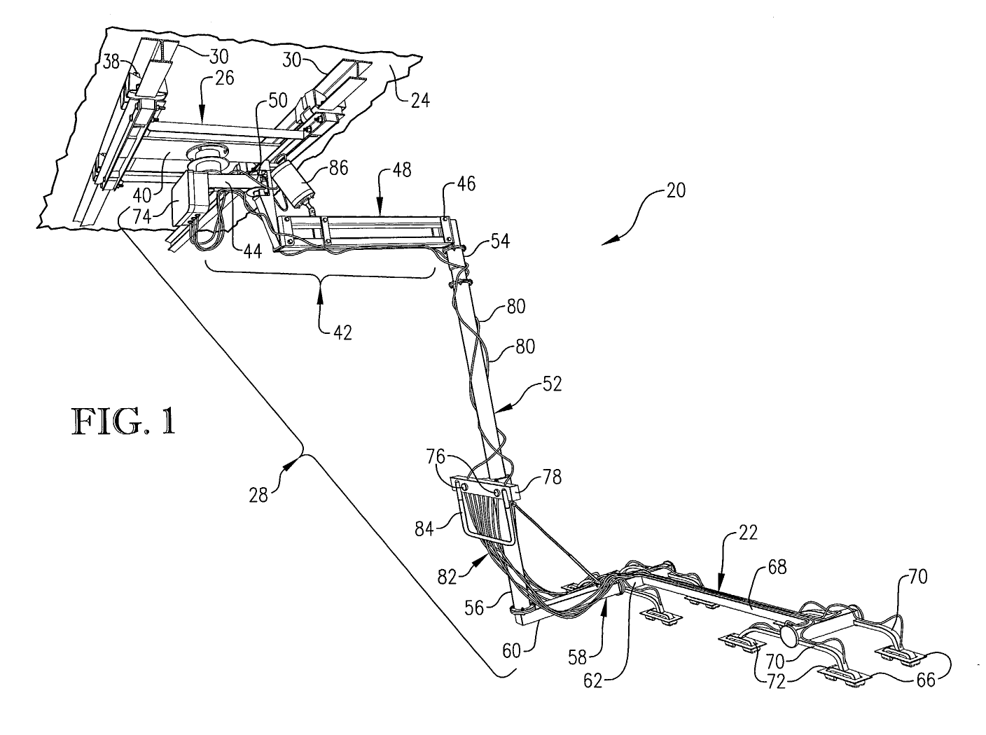

As shown in FIG. 1, in one embodiment of the present invention, a component part installer 20 is provided. Component part installer 20 comprises a component part carrier 22 shiftably coupled to a supporting surface 24 via a carriage 26 and an arm assembly 28.

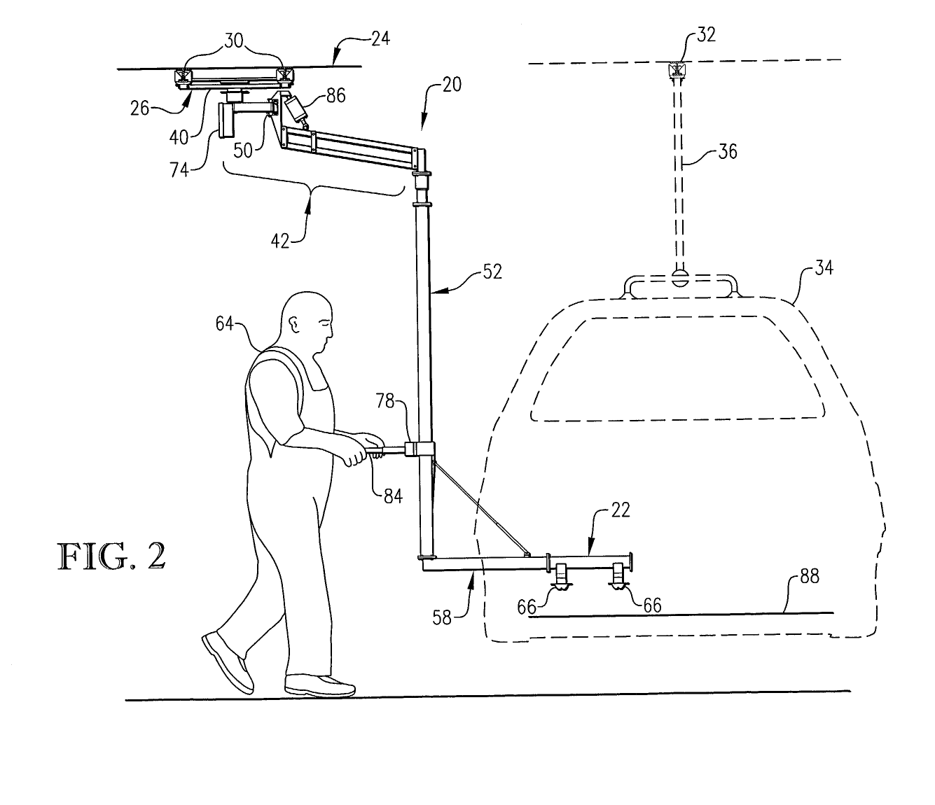

Referring now to FIGS. 1 and 2, supporting surface 24 can be any stable horizontal, vertical or angled surface capable of rigidly supporting the weight and torque imparted by component part carrier 22, carriage 26 and arm assembly 28. Preferably, supporting surface 12 is a substantially horizontal overhead surface. Supporting surface 24 can include overhead horizontally extending rails 30. Rails 30 preferably extend in a substantially horizontal direction corresponding to the direction of travel of an assembly line. As best seen in FIG. 2, rails 30 are substantially parallel to an assembly line track 32 which supports a vehicle body 34 via a suspension device 36. Rails 30 are horizontally spaced from the track 32 and the vehicle body 34 so that component part carrier 22 can translate along the rails 30 and the arm assembly 28 can translate in and out of an opening, typically a door opening, in vehicle body 34.

As best seen in FIG. 1, carriage 26 is shiftably coupled to rails 30 by any means known in the art for providing translation of carriage 26 along rails 30. Preferably, carriage 26 comprises a plurality of rollers 38 for providing translation along rails 30. Carriage 26 further comprises a base 40 for rigidly supporting arm assembly 28.

As best seen in FIG. 1, arm assembly 28 is physically interposed between carriage 26 and component part carrier 22. Assembly arm 28 provides translation of component part carrier 22 relative to carriage 26. Arm assembly 28 also provides support for component part carrier 22 so that the downward force exerted on arm assembly 28, due to the weight of component part carrier 22, is at least partially counteracted by the upward bias of arm assembly 28.

Arm assembly 28 comprises a first member 42 having a pivot end 44 and a swing end 46. Pivot end 44 is pivotably coupled to base 40 so that swing end 46 can rotate about pivot end 44. First member 42 preferably projects in a substantially horizontal direction so that swing end 46 can be rotated substantially horizontally about pivot end 44. In addition, swing end 46 is preferably capable of vertical translation relative to pivot end 44. Such vertical translation of swing end 46 can be provided by any means known in the art. For example, vertical translation of swing end 46 can be provided by a four-bar linkage assembly 48. First member 42 can include a hinge 50 located between pivot end 44 and swing end 46. Hinge 50 provides a substantially vertical pivot axis in first member 44 and allows swing end 46 to be rotated substantially horizontally relative to hinge 50.

Arm assembly 28 further comprises a second member 52 having a first end 54 and a second end 56. First end 54 is rotatably coupled to swing end 46 so that second member 52 can rotate around its longitudinal axis. Second member 52 is preferably maintained in a substantially upright position with first end 54 being spaced vertically higher than second end 56. Four-bar linkage assembly 48 is preferably configured so that when swing end 46 translates vertically, second member 52 remains in a substantially upright position. In an alternative embodiment, not shown, second member 52 can comprise a four-bar linkage assembly for providing substantially horizontal translation of second end 56 relative to first end 54.

Arm assembly 28 further comprises a third member 58 having a proximal end 60 and a distal end 62. Proximal end 60 is fixedly attached to second end 56. Distal end 62 is fixedly attached to component part carrier 22. Third member 58 is preferably maintained in a substantially horizontal position during translation of component part carrier 22. Third member 58 is preferably spaced vertically lower than first member 42.

A translation force can be applied to arm assembly 28 by any means known in the art for providing horizontal and vertical movement of a mechanical arm. As shown in FIG. 2, the translation force can be provided manually by an operator 64 to provide selective placement of the arm assembly relative to the part receiving platform. Alternatively, the translation force can be provided by suitable automatically controllable mechanical devices known in the art. Further, the path of translation of arm assembly 28 can be controlled manually by operator 64, as shown in FIG. 2, or by any suitable programmable automated device known in the art. Preferably, the translation force and translation path are provided by operator 64 who can inspect the vehicle body during part placement for quality assurance.

Referring back to FIG. 1, component part carrier 22 is preferably a rigid frame capable of supporting a plurality of component parts 66 in a substantially fixed spatial relationship. Component part carrier 22 comprises an upper main member 68, a plurality of legs 70 and a plurality of part receivers 72. Each leg 70 has a proximal end fixedly attached to upper main member 68, and a distal end fixedly attached to a respective part receiver 72. Preferably, component part carrier 22 has four or more part receivers 72, most preferably eight part receivers 72. Each part receiver 72 is adapted for selectively holding and releasing a respective component part 66. Each part receiver 72 preferably has at least one contact surface adapted to form a substantially flush fit with a portion of the surface of a respective component part 66. Most preferably, each part receiver has at least two contact surfaces adapted to fit in registry with a surface of a respective component part 66.

The contact surface of each part receiver is fluidically connected with a vacuum source circuit. The vacuum source circuit comprises a vacuum source 74 and a switch 76. Switch 76 is selectively actuatable to commence and at least partially terminate the flow of air from part receivers 72 to vacuum source 74, such as by permitting the flow of air into the vacuum source 74 directly at the switch 76 or at another location along the circuit. When switch 76 is actuated to commence the flow of air from part receivers 72 to vacuum source 74 and the contact surfaces of part receivers 72 are simultaneously contacted with respective component parts 66, component parts 66 are temporarily attached to part receivers 72 by vacuum attachment. When switch 76 is actuated to at least partially discontinue the flow of air from part receivers 72 to vacuum source 74, component parts 66 are released from part receivers 72.

Vacuum source 74 can be any conventional air displacement device capable of creating a sufficient vacuum attachment force so that component parts 66 can be temporarily attached to part receivers 72 by vacuum attachment. As shown in the drawings, the vacuum source 74 is a vacuum pump coupled for movement with the carriage 26, but alternatively the vacuum pump may be remotely located and connected by a length of flexible pneumatic tubing of sufficient length to connect to the carriage 26 and permit the carriage 26 to move along the rails 30.

Switch 76 is preferably manually actuatable by the operator and is fluidly interposed between vacuum source 74 and part receivers 72. Switch 76 may be any conventional electrical or pneumatic control device that is selectively actuatable to at least partially discontinue the flow of air from part receivers 72 to vacuum source 74. Preferably, switch 76 is a pneumatic switch.

Switch 76 is preferably mounted on a manifold 78. Manifold 78 is fixedly attached to second member 52. Manifold 78 is fluidly interposed between vacuum source 74 and part receivers 72. Manifold 78 is fluidically coupled to vacuum source 74 via at least one trunk line 80. Manifold 78 is fluidically coupled to part receivers 72 via a plurality of feeder lines 82. Manifold 78 is adapted to distribute the negative pressure created in trunk lines 80 by vacuum source 74 substantially evenly among feeder lines 82 so that each part receiver 72 exerts a substantially equal vacuum attachment force on each respective component part 66.

A handle 84 is preferably mounted on manifold 78 in close proximity to switch 76. Handle 84 facilitates manual translation of component part carrier 22. Further, handle 84 is positioned so that switch 76 can be actuated by human hands without releasing handle 84.

Component part installer 20 can further comprise a counter-force device 86. Counter-force device 86 provides a stabilizing, lifting force which acts on the arm assembly 28 to which it is connected. Preferably, the upward bias of arm assembly 28 at least partially counteracts the downward force exerted on arm assembly 28 by the weight of arm assembly 28, component part carrier 22, and component parts 66. Counter-force device 86 is preferably mounted on first member 42 so that an upward bias is provided to swing end 46 relative to pivot end 44. Counter-force device 86 can be coupled to a portion of first member 42 which extends vertically above four-bar linkage assembly 48. In this configuration, counter-force device 86 provides an upward bias to swing end 46 by pulling upward on the top member of four-bar linkage assembly 48. As best seen in FIG. 2, counter-force device 64 preferably provides sufficient upward bias on first member 42 such that an operator 64 can repeatedly facilitate the translation of component part carrier 22 in both horizontal and vertical directions without exerting a human-fatiguing translation force. The counter-force device 64 may be a simple spring or other device well known to those skilled in the art.

In an alternative embodiment, not shown, counter-force device 86 can be interposed at an angle between the upper and lower substantially horizontal members of four-bar linkage 48. In such an alternative embodiment, counter-force device 86 is preferably placed at an angle such that the end of counter-force device 86 connected to the upper substantially horizontal member of four-bar linkage assembly 48 is positioned closer to swing end 46 than the end of counter-force device 86 connected to the lower substantially horizontally projecting member of four-bar linkage assembly 48.

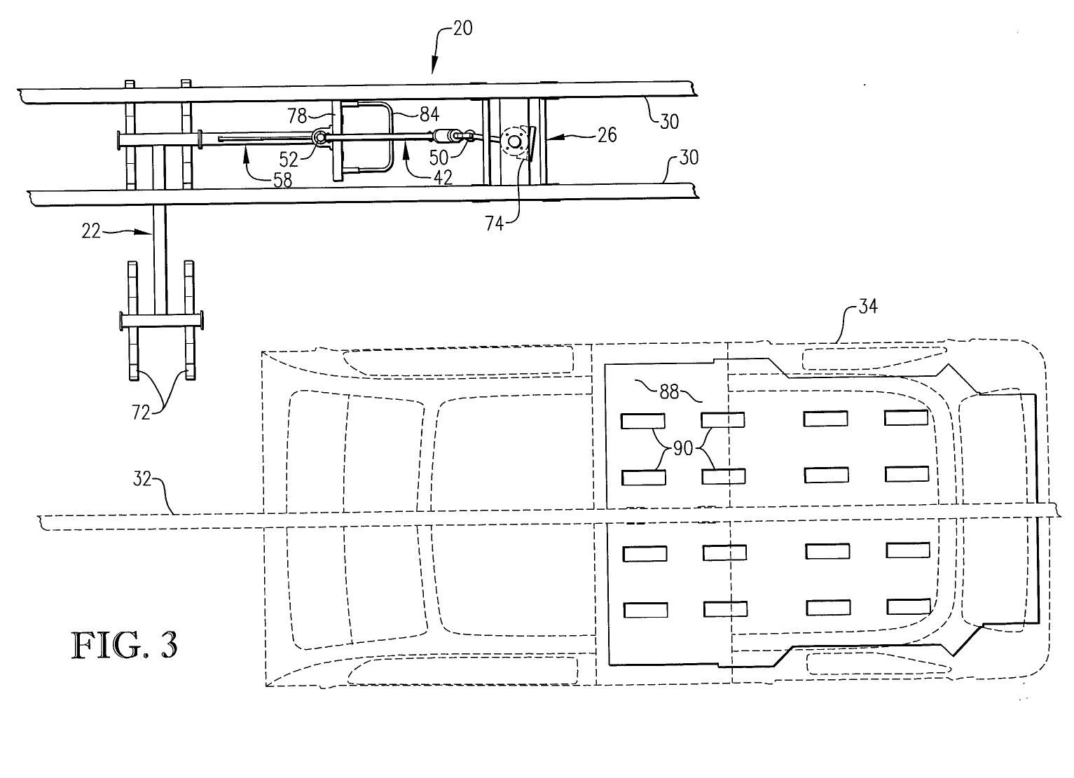

FIGS. 2-5, shown in a preferred embodiment of the present invention of, the installation of a plurality of component parts 66 in a platform 88. As best seen in FIGS. 3-5, platform 88 may be the floor of vehicle body 34 having a plurality of part reception sites 90. Part reception sites 90 have a fixed spatial relationship to each other. Part reception sites 90 illustrated herein are cavities in the floor pan of vehicle body 34 where seat anchoring devices extend upward from under the floor pan. The spatial relationship of part reception sites 70 is substantially the same as the spatial relationship of part receivers 72.

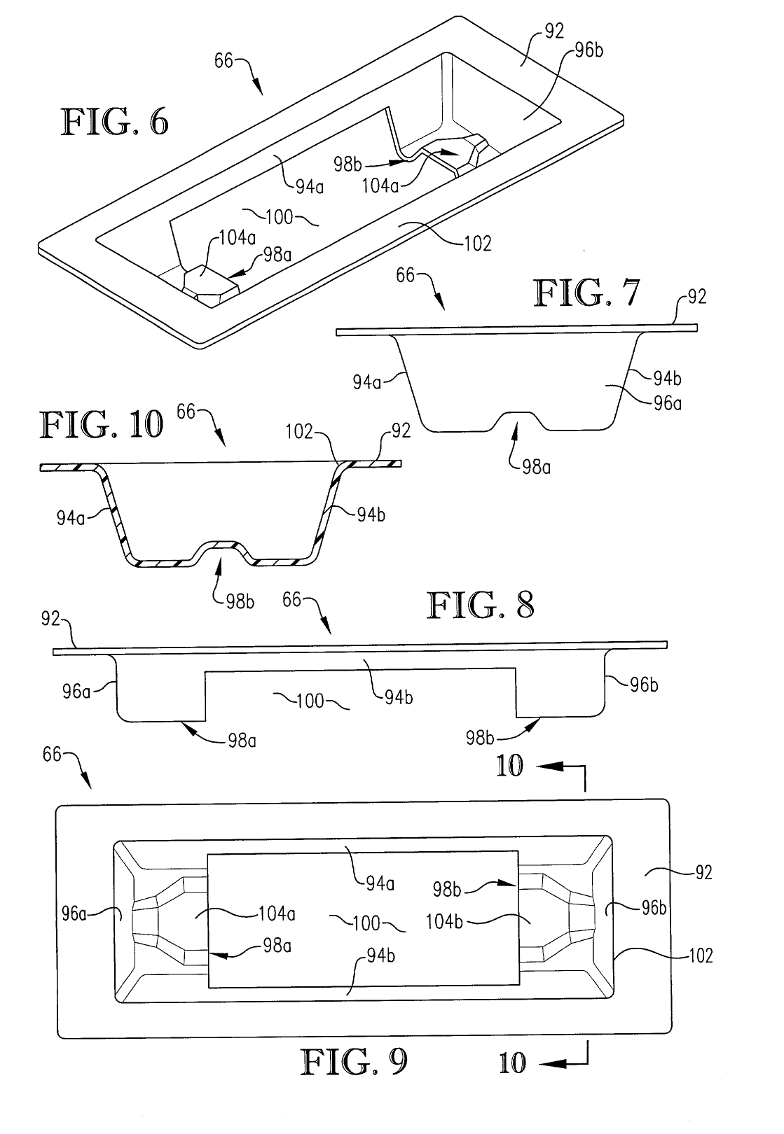

By way of an example of one type of part which may be installed in accordance with the present invention, FIGS. 6-10 show component part 66 as a one-piece thermally expandable, flexible sealing member which is configured to correspond to the overall shape and size of part reception sites 90. Of course, the part receivers 72 may be configured to hold and install other parts, the flexible sealing member illustrated being only one example thereof. In more detail, the illustrated component part 66 comprises a substantially rectangular lip 92, sidewalls 94a,b, end walls 96a,b, bottom portions 98a,b, and an opening 100. Sidewalls 94a,b and endwalls 96a,b extend downwardly from an inner periphery 102 of lip 92 to bottom portions 98a,b. Opening 100 separates bottom portions 98a,b. Bottom portions 98a,b comprise upper surfaces 104a,b which are substantially flat along a plane which is substantially parallel to that of lip 92. Component part 66 is preferably formed of a thermoplastic material. More preferably, component part 66 is formed of a polymeric base which includes ethylene vinyl acetate (EVA) and an elastomer.

Referring back to FIGS. 1-5, to simultaneously install multiple component parts 66 in reception sites 90, component part carrier 10 must first be loaded with component parts 66. While component part carrier 22 is retracted from vehicle body 34, as shown in FIG. 3, upper surfaces 104a,b of component part 66, shown in FIG. 6, are contacted with contact surfaces of part receivers 72. The flow of air from the part receivers 72 to the vacuum source 74 temporarily attaches component parts 66 to part receivers 72 by vacuum attachment.

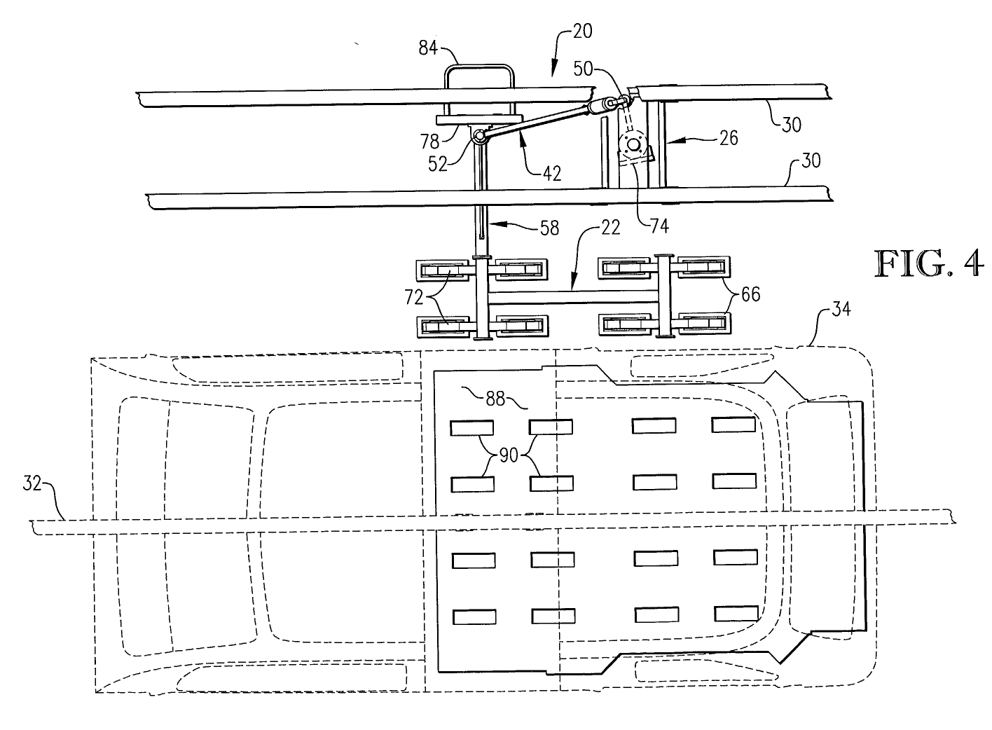

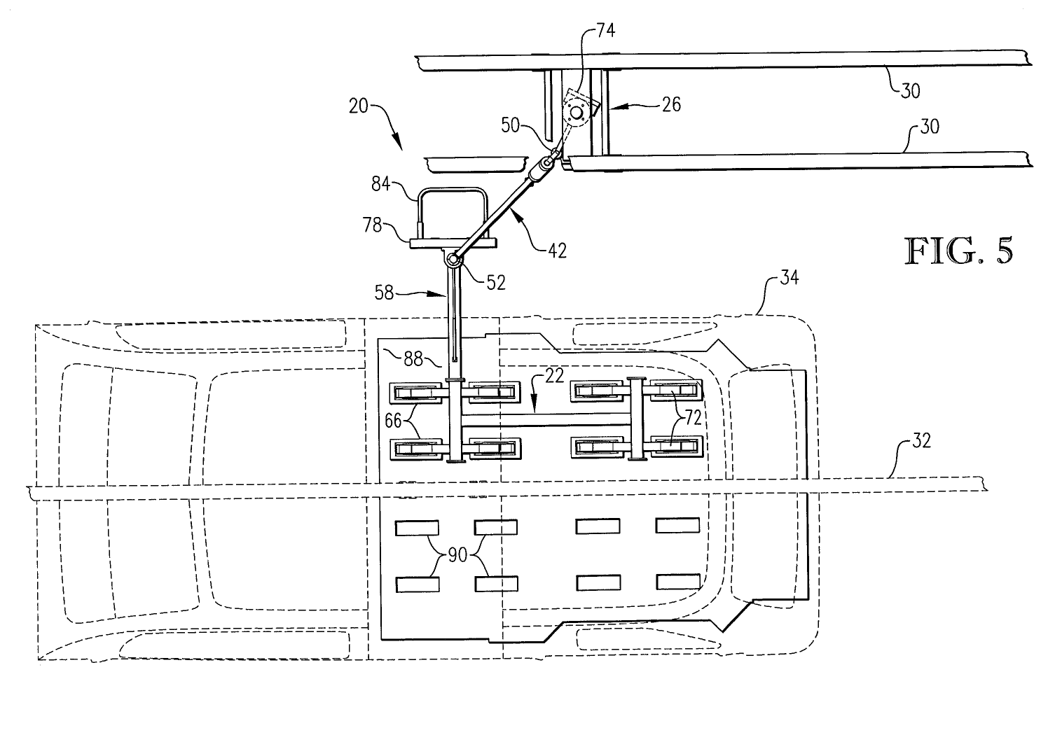

While component parts 66 are attached to part receivers 72 by a vacuum attachment, operator 64, shown in FIG. 2, translates the carriage 26 along its rails 30 to follow the movement of the vehicle body 34 along its track 32 and shifts the component part carrier 22 from a retracted position, shown in FIG. 3, to a position adjacent to an opening in vehicle body 34, shown in FIG. 4. As best shown in FIGS. 2 and 5, operator 64 translates component part carrier 22 through the opening in vehicle body 34 and into the interior of vehicle body 34. The component part carrier is positioned so that component parts 66 are substantially aligned with part reception sites 90. Component part carrier 22 is then lowered so that component parts 66 are in registry with corresponding part reception sites 90. Advantageously, the carrier 22 remains substantially horizontal during the installation process whereby the component parts 66 are retained on their respective part receivers 72 and remain oriented in position for installation.

While component parts 66 are in registry with part reception sites 90, switch 76, shown in FIG. 1, can be actuated to at least partially discontinue the flow of air from part receivers 72 to vacuum source 74, thereby releasing component parts 66 from part receivers 72. Before part receivers 72 are removed from component parts 66, component part carrier 22 can be shifted downward to force component parts 66 further into part reception sites 90, thereby forming a snug fit between component parts 66 and part reception sites 90 so that component parts 66 maintain registry with part reception sites 90 during movement of platform 88. The component part carrier can then be shifted to remove part receivers 72 from component parts 66, thereby leaving component parts 66 disposed within part reception sites 90. Component part carrier 22 can then be removed from the interior of vehicle body 34 to a retracted position for loading a new set of component parts 66.

As shown in FIG. 2, during the above-described installation process, vehicle body 34 can be traveling along an assembly line via assembly line track 32 and suspension device 36. Carriage 26 can be translated in a direction corresponding to the direction of travel of vehicle body 34 along the assembly line, thereby allowing multiple component parts to be simultaneously installed in platform 88 while platform 88 is in continuous motion.

From the foregoing, it will be seen that this invention is well adapted to attain the objects herein above set forth, together with other advantages which are inherent to the structure. It will be understood that certain features and subcombinations are of utility and may be employed without reference to other features and subcombinations. This is contemplated by and is within the scope of the claims.

Since many possible embodiments may be made of the invention without departing from the scope hereto, it is to be understood that all matter herein set forth or shown in the accompanying drawings is to be interpreted as illustrated and not in a limiting sense.

claims:

1. An apparatus comprising:
a support member;
a carriage shiftably coupled to the support member;
a component part carrier connected to said carriage, said component part carrier having a plurality of part receivers positioned in substantially fixed spatial relationship to one another, each part receiver adapted for selectively holding and releasing a respective component part; and
a vacuum source circuit fluidically connected to the plurality of part receivers, said vacuum source circuit including a vacuum source and a switch selectively actuatable to at least partially discontinue the flow of air from the plurality of part receivers to the vacuum source for thereby permitting the simultaneous release of component parts from their respective part receivers.

2. An apparatus as claimed in claim 1, wherein said carriage translates relative to the support member.

3. The apparatus as claimed in claim 1, wherein each part receiver has a contact surface adapted to form a substantially flush fit with a portion of the surface of the respective component part.

4. An apparatus as claimed in claim 1, wherein the plurality of component parts are adapted to fit within a plurality of reception sites in a platform.

5. An apparatus as claimed in claim 4, wherein the relative spatial relationship of the plurality of part receivers is fixed.

6. An apparatus as claimed in claim 5, wherein said carriage translates relative to the support member.

7. An apparatus as claimed in claim 6, wherein each part receiver has a contact surface adapted to form a substantially flush fit with a portion of the surface of the respective component part.

8. An apparatus as claimed in claim 7, wherein said carriage translates along the supporting member in a direction that corresponds to the direction of translation of the platform.

9. An apparatus as claimed in claim 8, wherein said component part is a flexible sealing member having an outer planar surface surrounding an inner recessed surface, said inner recessed surface having an opening therein.

10. An apparatus as claimed in claim 9, wherein each part receiver has two contact surfaces adapted to contact the inner recessed surface of the respective component part.

11. An apparatus according to claim 10 further comprising an arm assembly connecting the component part carrier to the carriage and providing multi-directional translation of the component part carrier relative to the carriage.

12. An apparatus as claimed in claim 11, wherein said platform is a floor of a vehicle.

13. An apparatus as claimed in claim 12, wherein said vehicle is on an assembly line.

13. An apparatus comprising:
a carriage coupled to a support member;
a component part carrier having a plurality of part receivers positioned in a substantially fixed spatial relationship to one another, each part receiver adapted for selectively holding and releasing a respective component part;
an arm assembly connecting the component part carrier to the carriage and providing translation of the component part carrier relative to the carriage; and
a vacuum source circuit fluidically connected to the plurality of part receivers, said vacuum source circuit including a vacuum source and a switch selectively actuatable to (a) permit a flow of air from the plurality of part receivers to the vacuum source for retaining the plurality of component parts to the plurality of part receivers, and (b) at least partially discontinue the flow of air from the plurality of part receivers to the vacuum source for thereby releasing the plurality of component parts from the plurality of part receivers.

14. An apparatus as claimed in claim 13, wherein said arm assembly comprises:
a first member having a pivot end and a swing end, said pivot end pivotably coupled to the carriage;
a second member having a first end, a second end, and a longitudinal axis, said first end rotatably coupled to the swing end so that the second member is capable of rotation around the longitudinal axis; and
a third member having a proximal end and a distal end, said proximal end fixedly attached to the second end, said distal end fixedly attached to the component part carrier.

15. An apparatus as claimed in claim 14, wherein said first member and said third member extend in a substantially horizontal direction and the second member is maintained in a substantially upright position.

16. An apparatus according to claim 15, wherein said first member is vertically positioned higher than the third member and said second member projects downwardly from the first member to the third member.

17. An apparatus as claimed in claim 16, wherein said swing end is substantially horizontally rotatable around the pivot end.

18. An apparatus as claimed in claim 17, wherein said first member comprises a four-bar linkage assembly allowing the swing end to translate substantially vertically relative to the pivot end while the second member is maintained in a substantially upright position.

19. An apparatus as claimed in claim 16, further comprising a counter-force device for at least partially counteracting downward vertical forces imparted on the arm assembly.

20. An apparatus as claimed in claim 19, wherein said counter-force device provides an upward bias on the first member.

21. An apparatus as claimed in claim 16, further comprising a handle fixedly attached to the second member for facilitating manual translation of the component part carrier, said handle located proximate to the switch so that the switch may be actuated without releasing the handle.

22. An apparatus as claimed in claim 21, wherein said carriage translates relative to the support member.

23. An apparatus as claimed in claim 22, wherein each part receiver has a contact surface adapted to form a substantially flush fit with a portion of the surface of the respective component part.

24. An apparatus for placing a plurality of flexible sealing members in a plurality of recesses in a floor of a vehicle moving along an assembly line, said apparatus comprising:
a carriage shiftably coupled to a supporting surface, said carriage adapted to translate to a direction corresponding to the direction of travel of the vehicle along the assembly line;
a component part carrier having a plurality of part receivers positioned in substantially fixed spatially relationship to one another, each part receiver adapted for selectively holding and releasing a respective component part, each part receiver having a contact surface adapted to form a substantially flush fit with a portion of the surface of the respective component part;
an arm assembly connecting said component part carrier to said carriage and providing translation of the component part carrier relative to the carriage, said arm assembly having a first substantially horizontally projecting member having a pivot end and a swing end, said pivot end pivotably coupled to the carriage so that the swing end rotates substantially horizontally around the pivot end, a substantially vertically projecting member having an upper end, a lower end, and a longitudinal axis, said upper end rotatably coupled to the swing end so that the substantially vertically projecting member is capable of rotating around the longitudinal axis, a second substantially horizontally projecting member having a proximal end and a distal end, said proximal end fixedly attached to the lower end, and said distal end fixedly attached to the component part carrier, and a counter-force device exerting an upward force on the first substantially horizontally projecting member which substantially counteracts the downward force on the first substantially horizontally projecting member; and
a vacuum source circuit fluidically connected to the plurality of part receivers, said vacuum source circuit including a vacuum source and a switch selectively actuatable to at least partially discontinue the flow of air from the plurality of part receivers to the vacuum source for thereby releasing the plurality of component parts from the plurality of part receivers.

25. An apparatus as claimed in claim 24, wherein said first member is a four-bar linkage assembly allowing the swing end to translate vertically relative to the pivot end while the substantially vertically projecting member is maintained in a substantially upright position.

26. An apparatus as claimed in claim 25, wherein said component part is a flexible sealing member having an outer planar surface surrounding an inner recessed surface.

27. A method of simultaneously installing a plurality of component parts into a moving platform, said method comprising:
(a) providing a plurality of component parts;
(b) providing a component part carrier having a plurality of part receivers positioned in a fixed spatial relationship to each other;
(c) providing a vacuum source fluidically connected to the plurality of part receivers thereby commencing the flow of air from the plurality of part receivers to the vacuum source;
(d) contacting the plurality of part receivers with the plurality of component parts and temporarily attaching the plurality component parts to the plurality of part receivers by vacuum attachment;
(e) translating the component part carrier to position the plurality of component parts in registry with a corresponding plurality of part reception sites in the platform; and
(f) at least partially discontinuing the flow of air from the plurality of part receivers to the vacuum source, thereby releasing the plurality of component parts from the plurality of part receivers.

28. A method as claimed in claim 27, further comprising:
(g) shifting the component part carrier relative to the platform to maintain registry of the plurality of part receivers relative to the plurality of part reception sites during movement of the platform.

29. A method as claimed in claim 28, further comprising
(h) shifting the component part carrier to position the plurality of part receivers out of registry with the plurality of part reception sites, said plurality of component parts remaining in the plurality of part reception sites.

30. A method as claimed in claim 29, wherein said platform is the floor of a vehicle.

31. A method as claimed in claim 30, wherein said component part is a flexible sealing member.
